(19) United States
(12) Patent Application Publication
(10) Pub. No.: US 2025/0354000 A1
(43) Pub. Date: Nov. 20, 2025

(54) RUBBER COMPOSITION

(71) Applicant: THE YOKOHAMA RUBBER CO., LTD., HIRATSUKA-SHI (JP)

(72) Inventors: Tomoyuki SAKAI, HIRATSUKA-SHI (JP); Takahiro OKAMATSU, HIRATSUKA-SHI (JP)

(21) Appl. No.: 19/202,321

(22) Filed: May 8, 2025

(30) Foreign Application Priority Data
May 14, 2024 (JP) 2024-078559

(51) Int. Cl. C08L 9/00; C08K 5/3417

(52) U.S. Cl. CPC C08L 9/00; C08K 5/3417; C08L 2201/08

(57) ABSTRACT

Provided is a rubber composition not only excellent in stain resistance but also exhibiting anti-aging properties equal to or superior to those of a rubber composition containing an amine-based anti-aging agent in the related art. The rubber composition containing: 100 parts by mass of a diene rubber; and 0.1 to 20 parts by mass of a substituted indole having a melting point of 200° C. or lower and being a compound represented by Formula (1) described below:

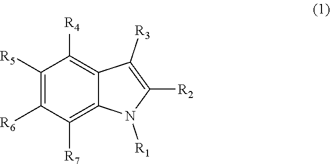

where R₁ to R₇ each independently represent a hydrogen atom or a substituent, with the proviso that at least one of R₁ to R₇ is a substituent.

### TECHNICAL FIELD

The present invention relates to a rubber composition.

### BACKGROUND ART

In the related art, a rubber composition containing an amine-based anti-aging agent (for example, N-phenyl-1-naphthylamine) as an anti-aging agent has been known (for example, Patent Document 1).

### CITATION LIST

### Patent Literature

Patent Document 1: J P 2013-095806 A

### SUMMARY OF INVENTION

### Technical Problem

However, such a rubber composition containing an amine-based anti-aging agent in the related art may be discolored to brown or the like during use (stain resistance is insufficient).

In light of such circumstances, an object of the present invention is to provide a rubber composition not only excellent in stain resistance but also exhibiting anti-aging properties equal to or superior to those of the rubber composition containing an amine-based anti-aging agent in the related art.

### Solution to Problem

As a result of diligent research on the issue described above, the present inventors have found that the issues described above can be solved by blending specific compounds in predetermined amounts, and completed the present invention.

In other words, the present inventors have found that the above-described issue can be solved by the following configurations.

(1) A rubber composition including:
100 parts by mass of a diene rubber; and
0.1 to 20 parts by mass of a substituted indole having a melting point of 200° C. or lower and being a compound represented by Formula (1) described below.

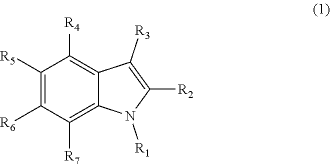

(2) The rubber composition according to (1), in which at least one of R 2 or R₃ in Formula (1) is a substituent having a carbon atom at a bonding position.

(3) The rubber composition according to (1) or (2), in which at least one of R₄ to R₇ in Formula (1) is a substituent having an oxygen atom at a bonding position.

(4) The rubber composition according to any one of (1) to (3), in which R₂ in Formula (1) contains an aromatic ring.

(5) The rubber composition according to any one of (1) to (4), in which a value of ¹⁴C disintegration per minute per gram of the substituted indole is 0.1 dpm/gC or more.

### Advantageous Effects of Invention

As described below, according to the present invention, it is possible to provide a rubber composition not only excellent in stain resistance but also exhibiting anti-aging properties equal to or superior to those of a rubber composition containing an amine-based anti-aging agent in the related art.

### DESCRIPTION OF EMBODIMENTS

A rubber composition according to an embodiment of the present invention will be described below.

In the present specification, a numerical range indicated using “(from) . . . to . . . ” includes the former number as the lower limit value and the latter number as the upper limit value.

For each component, one type may be used alone, or a combination of two or more types may be used. Here, when two or more types for each of the components are used in combination, the content of the corresponding component refers to the total content unless otherwise specified.

In addition, the anti-aging properties are exhibited to be equal to or superior to those of a rubber composition containing an amine-based anti-aging agent in the related art, which is referred to as “excellent anti-aging properties”.

In addition, excellent stain resistance and anti-aging properties are referred to as “excellent effects of the present invention”.

The rubber composition of the present invention (hereinafter also referred to as “the composition of the present invention”) is a rubber composition containing 100 parts by mass of a diene rubber and 0.1 to 20 parts by mass of a substituted indole (hereinafter also referred to as a “particular compound”) having a melting point of 200° C. or lower and being a compound represented by Formula (1) described below.

The composition of the present invention has such a configuration, which may be why the above issue is solved. Although the detailed mechanism is not clear, it is presumed as follows.

The present inventors have found that there is a correlation between the HOMO energy level and/or LUMO energy level of the compound and the anti-aging properties. The detailed mechanism for this is not clear, but it is thought that the ease of reaction with oxygen and ozone, which cause deterioration, is related to the energy level. Here, as described above, an amine-based anti-aging agent such as N-phenyl-1-naphthylamine is known to have an effect of suppressing deterioration. The energy level of indole (particular compound) into which a substituent is introduced is close to that of the amine-based anti-aging agent. In addition, the melting point of the particular compound is limited to a specific temperature or less, and thus the compatibility with the diene rubber is excellent. It is considered that this results in that the particular compound exhibits anti-aging properties equal to or superior to those of the amine-based anti-aging agent. The energy level of the particular compound becomes even closer to that of the amine-based anti-aging agent by adopting a preferred embodiment such as preferred embodiments 1 to 3 described below.

In addition, the particular compound does not have a structure in which an amino group is interposed between aromatic rings unlike an amine-based anti-aging agent such as N-phenyl-1-naphthylamine, and thus it is difficult to form a resonance structure (which leads to discoloration) if a hydrogen atom is extracted.

From the above points, it is considered that the composition of the present invention containing the particular compound exhibits excellent stain resistance and anti-aging properties.

Each of components in the composition according to an embodiment of the present invention will be described in detail below.

### Diene Rubber

The diene rubber contained in the composition of the present invention is not particularly limited.

The diene rubber may be modified with an alkoxy group, an alkoxysilyl group, or the like.

The composition of the present invention may contain one type of diene rubber or two or more types of diene rubbers.

### Specific Example

Specific examples of the diene rubber include natural rubber (NR), butadiene rubber (BR), aromatic vinyl-conjugated diene copolymer rubber, isoprene rubber (IR), acrylonitrile-butadiene copolymer rubber (NBR), butyl rubber (IIR), butyl halide rubber (Br-IIR, CI-IIR), and chloroprene rubber (CR). Examples of the aromatic vinyl-conjugated diene copolymer rubber include styrene-butadiene rubber (SBR), styrene-isoprene rubber, and butyl rubber.

### Molecular Weight

The weight average molecular weight (Mw) of the diene rubber is not particularly limited, but is preferably 100000 to 5000000, more preferably 200000 to 3000000, and further preferably 300000 to 2000000, from the view point that the effect of the present invention is more excellent.

In the present description, the weight average molecular weight (Mw) and the number average molecular weight (Mn) are each a value determined by gel permeation chromatography (GPC) measurement and a calibration using polystyrene standards.

### Particular Compound

The composition of the present invention contains a substituted indole (particular compound) having a melting point of 200° C. or lower and being a compound represented by the following Formula (1).

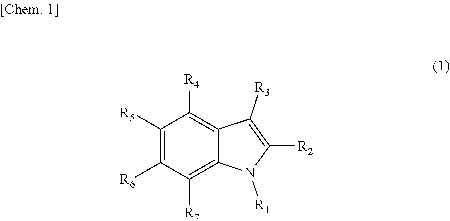

In Formula (1), R₁ to R₇ each independently represent a hydrogen atom or a substituent (for example, specific examples described below), with the proviso that at least one of R₁ to R₇ is a substituent.

For the reason that the effect of the present invention is more excellent, the above substituent is preferably a hydrocarbon group that may contain a heteroatom.

Examples of the hydrocarbon group include aliphatic hydrocarbon groups, aromatic hydrocarbon groups (aryl group), and groups that have a combination of these. The aliphatic hydrocarbon group may be in a form of straight-chain, branched-chain, or ring. Specific examples of the aliphatic hydrocarbon group include straight-chain or branched alkyl groups (especially, those having from 1 to 30 carbons), straight-chain or branched alkenyl groups (especially, those having from 2 to 30 carbons), and straight-chain or branched alkynyl groups (especially, those having from 2 to 30 carbons). Examples of the aromatic hydrocarbon group include aromatic hydrocarbon groups having from 6 to 18 carbons, such as a phenyl group, a tolyl group, a xylyl group, and a naphthyl group.

For the reason that the effect of the present invention is more excellent, the above R₁ is preferably an alkyl group. The number of carbons of the alkyl group is not particularly limited, but for the reason that the effect of the present invention is more excellent, the number is preferably from 1 to 10, and more preferably from 1 to 5. A carbon atom of the alkyl group may be substituted with —O—, —C(═O)—, —C(═O)—O—, —O—C(═O)—O—, —S—, —S(═O)—, —SO₂—, —NR— (where R is a hydrogen atom or a substituent (for example, specific examples described later)), or a group that has a combination of these groups.

For the reason that the effect of the present invention is more excellent, a group represented by *-L-R (hereinafter, referred to as “specific substituent” is also preferable. Here, L represents a single bond or a divalent linking group, R represents a hydrocarbon group, and * represents a bonding position.

Examples of the divalent linking group represented by L include divalent aliphatic hydrocarbon groups (particularly alkylene groups), divalent aromatic hydrocarbon groups (particularly arylene groups), —O—, —C(═O)—, —C(═O)—O—, —O—C(═O)—O—, —S—, —S(═O)—, —SO₂—, —NR— (where R is a hydrogen atom or a substituent (for example, specific examples described later)), and groups that have a combination of these.

Specific examples of the hydrocarbon group represented by R include those given above.

For the reason that the effect of the present invention is more excellent, the substituent is preferably a group represented by *-L-X. Here, L represents a single bond or a divalent linking group, X represents a substituent (for example, a specific example described below), and * represents a bonding position.

Specific examples of the divalent linking group represented by L include those given above.

### Preferred Embodiment 1

For the reason that the effect of the present invention is more excellent, the particular compound is preferably an embodiment in which at least one of R₂ or R₃ in Formula (1) is a substituent having a carbon atom at a bonding position (hereinafter, also referred to as “preferred embodiment 1”).

### Preferred Embodiment 2

For the reason that the effect of the present invention is more excellent, the particular compound is preferably an embodiment in which at least one of R₄ to R₇ in Formula (1) is a substituent having an oxygen atom at a bonding position (hereinafter, also referred to as “preferred embodiment 2”).

### Preferred Embodiment 3

For the reason that the effect of the present invention is more excellent, the particular compound is preferably an embodiment in which R 2 in Formula (1) includes an aromatic ring (hereinafter, also referred to as “preferred embodiment 3”).

### Preferred Embodiment 4

For the reason that the effect of the present invention is more excellent, the particular compound is preferably derived from natural products. Whether or not a particular compound is derived from a natural product can be investigated by, for example, 14° C. dating.

For the reason that the effect of the present invention is more excellent, the value of ¹⁴C disintegrations per minute per gram of the particular compound is preferably 0.1 dpm/gC or more. In the present description, the value of ¹⁴C disintegrations per minute per gram is a value measured by accelerator mass spectrometry (AMS) or liquid scintillation counting method (LSC).

### Melting Point

The melting point of the particular compound is 200° C. or lower. For the reason that the effect of the present invention is more excellent, the melting point is preferably 150° C. or less and more preferably 130° C. or lower. The lower limit of the melting point is not particularly limited, but for the reason that the effect of the present invention is more excellent, the lower limit is preferably 30° C. or higher, more preferably 50° C. or higher, and further preferably 70° C. or higher. The above melting point is a melting point at 1 atm.

### Content

In the composition according to the present invention, the content of the particular compound is from 0.1 to 20 parts by mass with respect to 100 parts by mass of the diene rubber described above. For the reason that the effect of the present invention is more excellent, the content is preferably from 0.5 to 10 parts by mass, and more preferably from 1 to 5 parts by mass.

### Specific Examples of Substituent

Specific examples of the substituent in the present description include a halogeno group (halogen atom), an alkyl group (e.g., a tert-butyl group) (including a cycloalkyl group, a bicycloalkyl group, and a tricycloalkyl group), an alkenyl group (including a cycloalkenyl group and a bicycloalkenyl group), an alkynyl group, an aryl group, a heterocyclic group (may be referred to as a heterocyclic group), a cyano group, a hydroxy group, a nitro group, a carboxy group, a formyl group, an alkoxy group, an aryloxy group, a silyloxy group, a heterocyclic oxy group, an acyloxy group, a carbamoyl group, a carbamoyloxy group, an alkoxycarbonyloxy group, an aryloxycarbonyloxy group, an amino group (including an anilino group), an ammonio group, a dialkylamino group, an acylamino group, an aminocarbonylamino group, an alkoxycarbonylamino group, an aryloxycarbonylamino group, a sulfamoylamino group, an alkyl or aryl sulfonylamino group, a mercapto group, an alkylthio group, an arylthio group, a heterocyclic thio group, a sulfamoyl group, a sulfo group, an alkyl or aryl sulfinyl group, an alkyl or aryl sulfonyl group, an acyl group, an aryloxycarbonyl group, an alkoxycarbonyl group, an aryl or heterocyclic azo group, an imide group, a phosphino group, a phosphinyl group, a phosphinyloxy group, a phosphinylamino group, a phosphono group, a silyl group, a hydrazino group, a ureide group, a boronic acid group (—B(OH)₂), a phosphato group (—OPO(OH)₂), a sulphato group (—OSO₃H), and other known substituents.

### Optional Component

The composition according to an embodiment of the present invention may further contain another additive (optional component) as necessary within the scope that does not impair the effect or purpose thereof.

Examples of the optional component include various additives that are typically used in rubber compositions, such as fillers (e.g., silica and carbon black), silane coupling agents, terpene resins (e.g., aromatic-modified terpene resins), thermally expandable microcapsules, zinc oxide (flower of zinc), stearic acid, anti-aging agents, waxes, processing aids, oils, liquid polymers, thermosetting resins, vulcanizing agents (e.g. sulfur), and vulcanization accelerators.

### Carbon Black

From the perspective of achieving superior effects of an embodiment of the present invention, the composition according to an embodiment of the present invention preferably contains carbon black.

The carbon black is not particularly limited and, for example, carbon blacks of various grades, such as SAF-HS, SAF, ISAF-HS, ISAF, ISAF-LS, IISAF-HS, HAF-HS, HAF, HAF-LS, and FEF, can be used.

The nitrogen adsorption specific surface area (N₂SA) of the carbon black is not particularly limited, but is preferably from 50 to 200 m²/g and more preferably from 70 to 150 m² g, from the perspective of achieving superior effects of an embodiment of the present invention.

Note that the nitrogen adsorption specific surface area (N₂SA) is a value of the amount of nitrogen adsorbed to the surface of carbon black, measured in accordance with JIS K 6217-2:2001 “Part 2: Determination of specific surface area-Nitrogen adsorption methods-Single-point procedures”.

### Content

When the composition according to the present invention contains carbon black, the content thereof is not particularly limited, but for the reason that the effect of the present invention is more excellent, the content is preferably from 2 to 100 parts by mass and more preferably from 20 to 50 parts by mass with respect to 100 parts by mass of the diene rubber described above.

### Silica

For the reason that the effect of the present invention is more excellent, the composition according to the present invention preferably contains silica.

The silica is not particularly limited, and any known silica can be used.

Examples of the silica include wet silica, dry silica, fumed silica, and diatomaceous earth. Silica derived from biomass, such as rice hulls, may also be used. One type of the silica may be used alone, or two or more types of the silicas may be used in combination.

The cetyltrimethylammonium bromide (CTA B) adsorption specific surface area (hereinafter, “CTAB adsorption specific surface area” is also simply referred to as “CTAB”) of the silica is not particularly limited, but is preferably from 100 to 300 m²/g, and more preferably from 150 to 200 m²/g, for the reason that the effect or the present invention is more excellent.

Here, the CTAB adsorption specific surface area is a value measured in accordance with JIS K 6430:2008 Annex G.

### Content

When the composition according to the present invention contains silica, the content thereof is not particularly limited, but for the reason that the effect of the present invention is more excellent, the content is preferably from 10 to 150 parts by mass and more preferably from 50 to 100 parts by mass with respect to 100 parts by mass of the diene rubber described above.

### Production Method

The method of producing the composition according to an embodiment of the present invention is not particularly limited, and specific examples thereof include a method whereby the above-mentioned components are kneaded using a known method and device (e.g., Banbury mixer, kneader, and roll). When the composition according to the present invention contains a vulcanizing agent (e.g., sulfur) and/or a vulcanization accelerator, the components other than the vulcanizing agent or the vulcanization accelerator are preferably mixed first at a high temperature (preferably from 100 to 155° C.) and cooled, and then the vulcanizing agent and/or the vulcanization accelerator is mixed.

The composition according to an embodiment of the present invention can be vulcanized or crosslinked under known vulcanizing or crosslinking conditions.

### Application

The composition according to the present invention is suitably used as a rubber material. The rubber composition is suitably used for, for example, a tire (especially, pneumatic tire), a conveyor belt, a hose, a vibration isolating material, a rubber roll, and an outside hood for a railway vehicle. Among these, the composition is suitably used for a tire (particularly, tire tread portion).

### EXAMPLES

An embodiment of the present invention will be described in further detail below by way of examples. However, an embodiment of the present invention is not limited to these examples.

### Production of Rubber Composition

The components shown in Table 1 below were mixed in compositions (part by mass) shown in the same table.

Specifically, first, the components listed in Table 1 below other than sulfur and a vulcanization accelerator were mixed in a 1.8-L sealed mixer for 5 minutes at 130° C., and thus a master batch was prepared. Thereafter, the sulfur and the vulcanization accelerator were added to the prepared master batch, and these were mixed with an open roll at 80° C., and thus each rubber composition was produced.

### Evaluation

The produced rubber composition was subjected to press vulcanization at 150° C. for 30 minutes to manufacture a vulcanized rubber sheet. The following evaluations were performed for the produced vulcanized rubber sheet.

### Stain Resistance

The appearance of the produced vulcanized rubber sheet (6×6 inches) after one month of outdoor exposure was visually observed, and the stain resistance was evaluated in accordance with the following criteria. “Good” indicates that the sample was excellent in stain resistance.
Good: No discoloration was observed.
Poor: Discoloration was observed.
   Maintenance Rate of Strength at Break and Maintenance rate of Elongation at Break

In accordance with JIS K 6251:2010, a JIS No. 3 dumbbell test piece (thickness: 2 mm) was punched out from the produced vulcanized rubber sheet, and the strength at break and the elongation at break were evaluated under the conditions of a temperature of 20° C. and a tensile speed of 500 mm/minute. In addition, the produced vulcanized rubber sheet was subjected to an aging test (left in an environment of 80° C. for 240 hours), and the strength at break and the elongation at break were evaluated in the same manner. Then, the maintenance rate of strength at break and maintenance rate of elongation at break were determined as follows. The results are listed in Table 1.

Maintenance rate of strength at break (%)=strength at break after aging test/strength at break before aging test×100

Maintenance rate of elongation at break (%)=elongation at break after aging test/elongation at break before aging test×100

As the maintenance rate of strength at break and the maintenance rate of elongation at break are higher, it indicates that anti-aging properties is more excellent. When the maintenance rate of strength at break is 80% or more and the maintenance rate of elongation at break is 75% or more, it indicates that the anti-aging properties are exhibited to be equal to or superior to those of the rubber composition containing an amine-based anti-aging agent in the related art.

TABLE 1

| | | Compar- | Compar- | Compar- | | | | | | | |
|---|---|---|---|---|---|---|---|---|---|---|---|
| | | ative | ative | ative | | | | | | | |
| | Reference | Example | Example | Example | Example | Example | Example | Example | Example | Example | Example |
| Table1 | Example | 1 | 2 | 3 | 1 | 2 | 3 | 4 | 5 | 6 | 7 |
| Natural rubber | 100 | 100 | 100 | 100 | 100 | 100 | 100 | 100 | 100 | 100 | 100 |
| Carbon black | 40 | 40 | 40 | 40 | 40 | 40 | 40 | 40 | 40 | 40 | 40 |
| Zinc oxide | 3 | 3 | 3 | 3 | 3 | 3 | 3 | 3 | 3 | 3 | 3 |
| Stearic acid | 1 | 1 | 1 | 1 | 1 | 1 | 1 | 1 | 1 | 1 | 1 |
| Oil | 5 | 5 | 5 | 5 | 5 | 5 | 5 | 5 | 5 | 5 | 5 |
| Naphthylamine | | 2 | | | | | | | | | |
| (62° C.) | | | | | | | | | | | |
| Indole (52° C.) | | | 2 | | | | | | | | |
| Tryptophan | | | | 2 | | | | | | | |
| (289° C.) | | | | | | | | | | | |
| Compound 1 | | | | | 2 | | | | | | |
| (117° C.) | | | | | | | | | | | |
| Compound 2 | | | | | | 2 | | | | | |
| (44 to 45° C.) | | | | | | | | | | | |
| Compound 3 | | | | | | | 2 | | | | |
| (107° C.) | | | | | | | | | | | |
| Compound 4 | | | | | | | | 2 | | | |
| (59° C.) | | | | | | | | | | | |
| Compound 5 | | | | | | | | | 2 | | |
| (192° C.) | | | | | | | | | | | |
| Compound 6 | | | | | | | | | | 2 | |
| (73° C.) | | | | | | | | | | | |
| Compound 7 | | | | | | | | | | | 2 |
| (90° C.) | | | | | | | | | | | |
| Sulfur | 1.5 | 1.5 | 1.5 | 1.5 | 1.5 | 1.5 | 1.5 | 1.5 | 1.5 | 1.5 | 1.5 |
| Vulcanization | 1 | 1 | 1 | 1 | 1 | 1 | 1 | 1 | 1 | 1 | 1 |
| accelerator TBBS | | | | | | | | | | | |
| Stain resistance | Good | Poor | Good | Good | Good | Good | Good | Good | Good | Good | Good |
| Maintenance | 75 | 80 | 78 | 77 | 86 | 84 | 83 | 85 | 82 | 84 | 80 |
| rate of | | | | | | | | | | | |
| strength at | | | | | | | | | | | |
| break (%) | | | | | | | | | | | |
| Maintenance | 71 | 77 | 72 | 70 | 89 | 86 | 80 | 79 | 78 | 82 | 75 |
| rate of | | | | | | | | | | | |
| elongation at | | | | | | | | | | | |
| break (%) | | | | | | | | | | | |

The temperatures shown in Table 1 represent the melting points of the components.

### Naphthylamine, Indole, Tryptophan, and Compounds 1 to 7

Among the components in Table 1, naphthylamine, indole, tryptophan, and compounds 1 to 7 are as follows. Naphthylamine, indole, and tryptophan do not correspond to the above-described particular compounds, and compounds 1 to 7 correspond to the above-described particular compounds. In addition, compounds 1 to 7 have 0.1 dpm/gC or more of the value of ¹⁴C disintegrations per minute per gram.
Naphthylamine: the following compound (melting point: 62° C.)

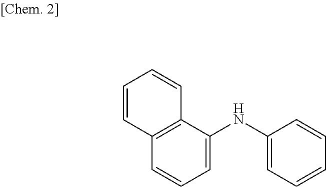 [SMILES: c1ccc(Nc2cccc3ccccc23)cc1]

Indole: the following compound (melting point: 52° C.)

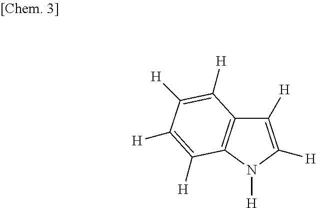

When indole is applied to Formula (1), all of R₁ to R 7 are hydrogen atoms, and thus indole does not correspond to the particular compound described above.
Tryptophan: the following compound (decomposition at melting point: 289° C.)

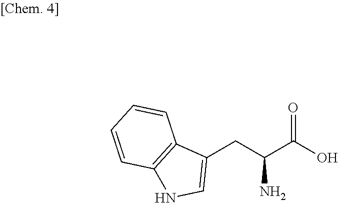 [SMILES: N[C@@H](Cc1c[nH]c2ccccc12)C(=O)O]

Although tryptophan is a compound represented by Formula (1), tryptophan does not correspond to the above-described particular compound because of the melting point higher than 200° C.

### Compound 1: Melatonin (the Following Compound, Melting Point: 117° C.)

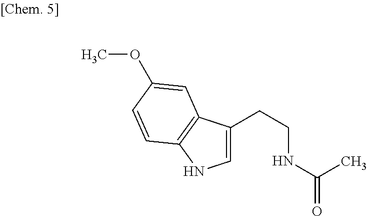 [SMILES: COc1ccc2[nH]cc(CCNC(C)=O)c2c1]

Compound 1 is a compound represented by Formula (1). Here, in Formula (1), R₃ is *—C₂H₄—NH—C(—O)—CH₃ (where * represents a bonding position), R₅ is a methoxy group, and R₁, R₂, R₄, R₆, and R 7 are hydrogen atoms. In addition, the melting point of Compound 1 is 200° C. or lower. Therefore, Compound 1 corresponds to the particular compound described above.

### Compound 2: Ethyl 3-Indoleacetate (the Following Compound, Melting Point: 44 to 45° C.)

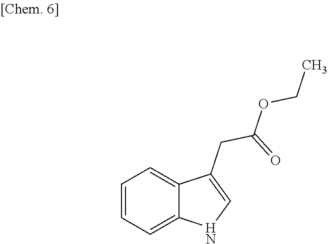

Compound 2 is a compound represented by Formula (1). Here, in Formula (1), R 3 is *—CH 2-C(═O)—O—C₂H₅ (where * represents a bonding position), and R₁, R₂, and R 4 to R₇ are hydrogen atoms. In addition, the melting point of Compound 2 is 200° C. or lower. Therefore, Compound 2 corresponds to the particular compound described above.

### Compound 3: 5-Hydroxyindole (the Following Compound, Melting Point: 107° C.)

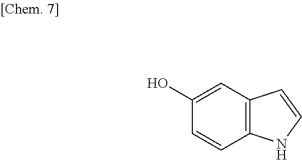

Compound 3 is a compound represented by Formula (1). Here, in Formula (1), R 5 is a hydroxy group, and R₁ to R₄, R₆, and R₇ are hydrogen atoms. In addition, the melting point of Compound 3 is 200° C. or lower. Therefore, Compound 3 corresponds to the particular compound described above.

### Compound 4: 3-Indoleethanol (the Following Compound, Melting Point: 59° C.)

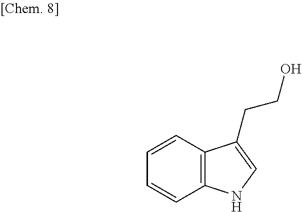 [SMILES: OCCc1c[nH]c2ccccc12]

Compound 4 is a compound represented by Formula (1). Here, in Formula (1), R 3 is *—C₂H₄—OH (where * represents a bonding position), and R₁, R 2, and R 4 to R₇ are hydrogen atoms. Compound 4 has a melting point of 200° C. or lower. Therefore, Compound 4 corresponds to the particular compound described above.

### Compound 5: 2-Phenylindole (the Following Compound, Melting Point: 192° C.)

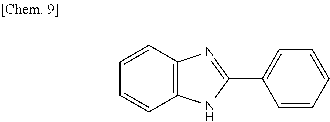 [SMILES: c1ccc(-c2nc3ccccc3[nH]2)cc1]

Compound 5 is a compound represented by Formula (1). Here, in Formula (1), R₂ is a phenyl group, and R₁ and R₃ to R₇ are hydrogen atoms. Compound 5 has a melting point of 200° C. or lower. Therefore, Compound 5 corresponds to the particular compound described above.

### Compound 6: 7-Benzyloxyindole (the Following Compound, Melting Point: 73° C.)

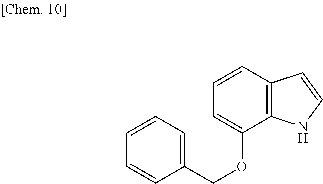 [SMILES: c1ccc(COc2cccc3cc[nH]c23)cc1]

Compound 6 is a compound represented by Formula (1). Here, in Formula (1), R 7 is a benzyl group, and R₁ to R₆ are hydrogen atoms. Compound 6 has a melting point of 200° C. or lower. Therefore, Compound 6 corresponds to the particular compound described above.

### Compound 7: Indole-7-Carboxaldehyde (the Following Compound, Melting Point: 90° C.)

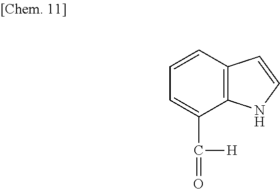 [SMILES: O=Cc1cccc2cc[nH]c12]

Compound 7 is a compound represented by Formula (1). Here, in Formula (1), R 7 is a formyl group, and R₁ to R₆ are hydrogen atoms. Compound 7 has a melting point of 200° C. or lower. Therefore, Compound 7 corresponds to the particular compound described above.

### Other Components

Other components in Table 1 are as follows.
Natural rubber: Natural rubber
Carbon black: Show Black N234 (available from Showa Cabot K.K.)
Zinc oxide: Zinc Oxide III (available from Seido Chemical Industry Ltd.)
Stearic acid: Beads stearic acid Y R (available from Nippon Oil & Fats Co., Ltd.)
Oil: Process oil
Sulfur: Oil treatment sulfur (available from Karuizawa Refinery Ltd.)·
Vulcanization accelerator TBBS: Sanceler NS-G (available from Sanshin Chemical Industry Co., Ltd.)

### Summary of Table 1

As can be seen from Table 1, in Examples 1 to 7 each containing a particular compound, excellent stain resistance and anti-aging properties were exhibited. Among them, in Examples 1 to 4 and Example 6 in which the melting point of the particular compound was 150° C. or lower and the particular compound was any one of the preferred embodiments 1 to 3, more excellent anti-aging properties were exhibited. Among them, in Examples 1 to 2 and Example 6 in which at least one of R₁ to R₇ in Formula (1) was a specific substituent, a higher maintenance rate of elongation at break was exhibited. Among them, in Examples 1 and 2 in which R₃ in Formula (1) was a substituent, a higher maintenance rate of elongation at break was exhibited.

In contrast, in Comparative Example 2 with indole in which all of R₁ to R₇ in Formula (1) are hydrogen atoms was used and in Comparative Example 3 with tryptophan that is a compound represented by Formula (1) but has a melting point of higher than 200° C., the anti-aging properties were insufficient. In addition, in Comparative Example 1 with naphthylamine that is an amine-based anti-aging agent in the related art, the stain resistance was insufficient.

1. A rubber composition comprising:
100 parts by mass of a diene rubber; and
0.1 to 20 parts by mass of a substituted indole having a melting point of 200° C. or lower and being a compound represented by Formula (1): 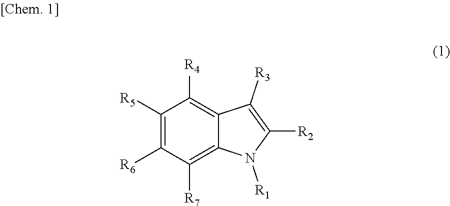
where R₁ to R 7 each independently represent a hydrogen atom or a substituent, with the proviso that at least one of R 1 to R₇ is a substituent.

2. The rubber composition according to claim 1, wherein at least one of R 2 or R₃ in Formula (1) is a substituent having a carbon atom at a bonding position.

3. The rubber composition according to claim 1, wherein at least one of R 4 to R₇ in Formula (1) is a substituent having an oxygen atom at a bonding position.

4. The rubber composition according to claim 1, wherein R 2 in Formula (1) includes an aromatic ring.

5. The rubber composition according to claim 1, wherein a value of ¹⁴C disintegration per minute per gram of the substituted indole is 0.1 dpm/gC or more.
